(19) United States
(12) Patent Application Publication
(10) Pub. No.: US 2005/0237462 A1
(43) Pub. Date: Oct. 27, 2005

(54) Alignment layer for liquid crystal display

(75) Inventors: Kelvin Nguyen, Rochester, NY (US); Robert P. Bourdelais, Pittsford, NY (US); Cheryl J. Brickey, Webster, NY (US); James F. Elman, Fairport, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/832,179

(22) Filed: Apr. 26, 2004

(51) Int. Cl. G02F 1/1337

(52) U.S. Cl. 349/130

(57) ABSTRACT

Disclosed is a liquid crystal alignment layer comprising a transparent substrate bearing a series of parallel nanogrooves in the surface thereof and containing in the nanogrooves an oriented liquid crystal material.

### FIELD OF THE INVENTION

This invention relates to an aligned liquid crystal layer comprising a transparent substrate bearing a series of parallel nanogrooves in the surface thereof and containing in the nanogrooves an oriented liquid crystal material.

### BACKGROUND OF THE INVENTION

Current rapid expansion in the liquid crystal display (LCD) applications in various areas of information display is largely due to improvements of display qualities. Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cells, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in liquid crystal displays is exacerbated by a shift in the brightness-voltage curve as a function of viewing angle because of the optical anisotropy of the liquid crystal material.

Thus, one of the major factors measuring the quality of such displays is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to insert a compensator (also referred as compensation film, retardation film, or retarder) with proper optical properties between the polarizer and liquid crystal cell, such as disclosed in U.S. Pat. Nos. 5,583,679 (Ito et al.), 5,853,801 (Suga et al.), 5,619,352 (Koch et al.), 5,978,055 (Van De Witte et al.), and 6,160,597 (Schadt et al.).

A compensator according to U.S. Pat. Nos. 5,583,679 (Ito et al.) and 5,853,801 (Suga et al.), based on discotic liquid crystals, which have negative birefringence, is widely used. It offers improved contrast over wider viewing angles. However, this compensator contains an orientation layer that has been subjected to rubbing treatment, for which is difficult to vary or control the local pretilt angle of the optically anisotropic layer to the desired value.

WO 0,036,463 (Fünfschilling et al.) filed in 1999 teaches the method of using a photo-oriented linearly photopolymerised (LPP) layer to align liquid crystal material. This optical alignment is a non-mechanical, non-contact process, which does not generate dust particles or electrostatic charge but it adds an extra layer and some undesirable weight to the display device. Similarly, U.S. patents US2002/0132065A1 and U.S. Pat. No. 6,395,354B1 also require an extra oriented film of a lyotropic nematic liquid crystalline material to align the liquid crystal material.

Another way to make a compensator is to use a pair of crossed liquid crystal polymer (LCP) films on each side of liquid crystal cell, as discussed by Chen et al. (“Wide Viewing Angle Photoaligned Plastic Films”, SID 99 Digest, pp. 98-101 (1999)). This paper states that “since the second LPP/LCP retarder film is coated directly on top of the first LCP retarder film, the total thickness of the final wide-view retarder stack is only a few microns thin”. Although they provide very compact optical component, one of the challenges of this method is to make two LCP layers crossed, particularly in a continuous roll to roll manufacturing process.

It is a problem to be solved to provide a liquid crystal alignment layer that can also be used as a compensator that widens the viewing angle characteristics of liquid crystal displays, in particular Twisted Nematic (TN), Super Twisted Nematic (STN), Optically Compensated Bend (OCB), In Plane Switching (IPS), or Vertically Aligned (VA) liquid crystal displays, and does not require a separate alignment layer and rubbing steps.

### SUMMARY OF THE INVENTION

The invention provides a liquid crystal alignment layer comprising a transparent substrate bearing a series of parallel nanogrooves in the surface thereof and containing in the nanogrooves an oriented liquid crystal material. The aligned liquid crystal layer according to the current invention is useful for liquid crystal display modes, such as a Multi-domain Vertically Aligned (MVA), a Twisted Nematic (TN), a Super Twisted Nematic (STN), Optically Compensated Blend (OCP), and an In-Plane-Switching (IPS).

### BRIEF DESCRIPTION OF THE DRAWINGS

FIG. 1 shows the definition of the azimuthal angles to specify a direction of an optic axis.

FIG. 2A shows a top view of a transparent substrate bearing a series of parallel nanogrooves in the surface.

FIG. 2B shows a cross sectional view of a transparent substrate bearing a series of parallel nanogrooves in the surface.

FIG. 3 shows a cross sectional view of a transparent substrate bearing a series of parallel nanogrooves in the surface and containing in the nanogrooves an oriented liquid crystal material.

FIG. 4 shows a cross sectional view of a transparent substrate bearing a series of parallel nanogrooves in the surface and containing in the nanogrooves a barrier layer and an oriented liquid crystal material.

FIGS. 5A and 5B show a liquid crystal display with one and two compensators respectively.

### DETAILED DESCRIPTION OF THE INVENTION

The following terms have the definitions as stated below. “Nanogrooves” means trenches, furrows or conduits in the sheet of the invention where at least one of the dimensions (width, length, or depth) is less than 500 nanometers. The nanogrooves range in width and/or depth between 1 and 500 nanometers. The nanogrooves have a general direction in the plane of the sheet, although the nanogrooves can vary in the depth of the sheet. Nanogrooves in the plane of the sheet can be ordered rows or arrays, random in nature, straight, curved, circular, oval, square, triangular, sine waves, or square waves. The cross-sectional shape of the nanogrooves could be square, rectangular, triangular, rounded, or any other shape. The nanogrooves may be substantially parallel or more than one population of nanogrooves which could intersect with the other to form a grid pattern. The nanogrooves may be discrete or may intersect. In the sheet, there may be one or more nanogrooves.

Oriented liquid crystal means liquid crystal material oriented along a preferred direction

Transparent substrate means a film with total light transmission of 70% or greater at 500 nm.

Thermoplastic polymer means polymers that become soft when heated and hard when cooled.

Thermoset polymer means polymers that have the property of becoming permanently hard and rigid when heated or cured

Positive Birefringence means the extraordinary index (nₑ) is greater than the ordinary index (nₒ) in a uniaxial material.

Negative birefringence: means the ordinary index (nₒ) is greater than the extraordinary index (nₑ) in uniaxial material.

In-plane birefringence means the difference between nₓ and n_{y}, where x and y lie in the plane of the layer. nₓ will be defined as being parallel to the casting direction of the polymer, and n_{y} being perpendicular to the casting direction of the polymer film. The sign convention used will be nₓ−n_{y}.

Out of-plane birefringence means the difference between n_{z} and the average of nₓ and n_{y}, where x and y lie in the plane of the layer and z lies in the plane normal to the layer. The sign convention used will be: n_{z}−[(nₓ+n_{y})/2].

Polarizer refers to elements that polarize an electromagnetic wave.

Optic axis means the direction in which propagating light does not see birefringence.

The current invention regarding the optical compensator for liquid crystal displays is described by referring to the figures as follows.

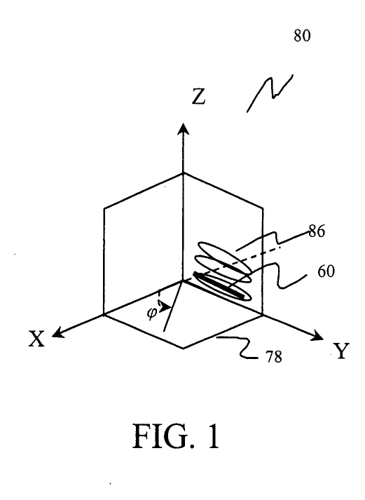

FIG. 1 illustrates an XYZ coordinate system 80. The X and Y axes are parallel to the plane of substrate 78, and the Z-axis is perpendicular to the plane of substrate 78. The angle φ is measured from the X-axis in the XY plane, and referred as an azimuthal angle. It should be understood that the optic axis of the liquid crystal layer 60 has a variable azimuthal angle. For example, the optic axis 86 is contained in one plane such as the X-Z plane and consequently has a fixed azimuthal angle φ across the Z-axis. In another example, although the liquid crystal layer 60 is still oriented along the preferred direction forced by the nanogrooves at their interface, the optic axis 86 has a variable azimuthal angle φ across the Z-axis. The azimuthal angle of the optic axis 86 can be varied by adding a proper amount of chiral dopant into the liquid crystal layer 60.

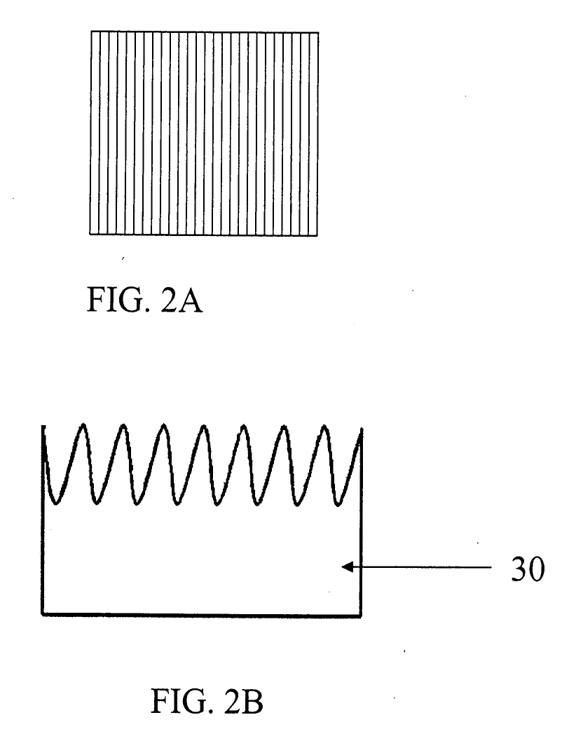

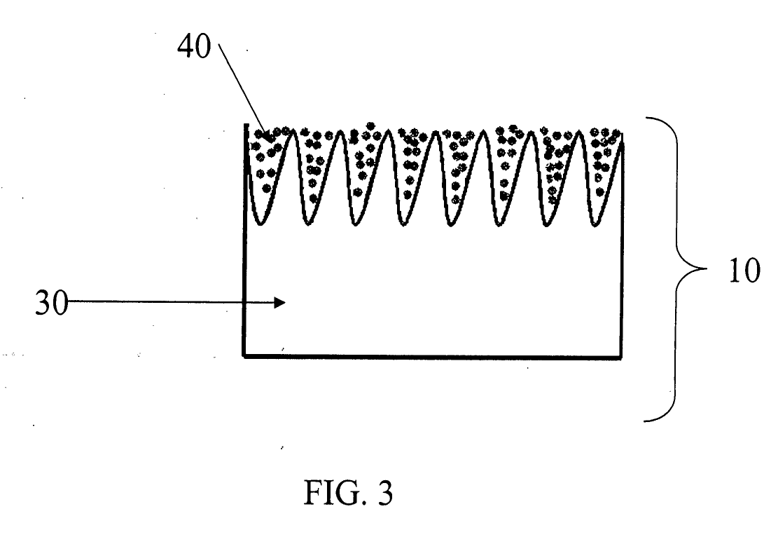

FIG. 2 shows a cross-sectional schematic view of an alignment according to the present invention. This alignment comprises a substrate 30 of transparent material, such as a polymer. It should be understood that to be called as a substrate, a layer must be solid and mechanically strong so that it can stand alone and support other layers. The transparent substrate 30 is coated from a solution containing a polymer that yields high negative birefringence upon solvent coating. To produce negative birefringence (negative retardation), polymers that contain non-visible chromophore groups such as vinyl, carbonyl, amide, imide, ester, carbonate, sulfone, azo, and aromatic groups (i.e. benzene, naphthalate, biphenyl, bisphenol A) in the polymer backbone will be used, such as polyesters, polycarbonates, polyimides, polyetherimides, and polythiophenes. Polymers that do not have chromophores in the backbone such as polystyrene, polymethyl methacrylate, and side chain liquid crystal polymers will produce positive birefringence.

A typical substrate is made of triacetate cellulose (TAC), polyester, polycarbonate, polysulfone, polyether sulfone, polystyrene, polymethyl methacrylate, cellophane, aromatic polyamide, polyethylene, polypropylene, polyvinyl alcohol, or other transparent polymers, and has a thickness of 25 to 500 micrometers. Polymers are preferred as they are generally lower in cost compared to glass surface features, have excellent optical properties and can be efficiently formed into lenses utilizing known processes such as melt extrusion, vacuum forming and injection molding. Preferred polymers for the formation of the complex lenses include polyolefins, polyesters, polyamides, polycarbonates, cellulosic esters, polystyrene, polyvinyl resins, polysulfonamides, polyethers, polyimides, polyvinylidene fluoride, polyurethanes, polyphenylenesulfides, polytetrafluoroethylene, polyacetals, polyacrylates, polysulfonates, polyester ionomers, and polyolefin ionomers. Copolymers and/or mixtures of these polymers to improve mechanical or optical properties can be used. Preferred polyamides for the transparent complex lenses include nylon 6, nylon 66, and mixtures thereof. Copolymers of polyamides are also suitable continuous phase polymers. An example of a useful polycarbonate is bisphenol-A polycarbonate. Cellulosic esters suitable for use as the continuous phase polymer of the complex lenses include cellulose nitrate, cellulose triacetate, cellulose diacetate, cellulose acetate propionate, cellulose acetate butyrate, and mixtures or copolymers thereof. Preferably, polyvinyl resins include polyvinyl chloride, poly(vinyl acetal), and mixtures thereof. Copolymers of vinyl resins can also be utilized. Preferred polyesters for the complex lens of the invention include those produced from aromatic, aliphatic or cycloaliphatic dicarboxylic acids of 4-20 carbon atoms and aliphatic or alicyclic glycols having from 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexanedicarboxylic, sodiosulfoisophthalic and mixtures thereof. Examples of suitable glycols include ethylene glycol, propylene glycol, butanediol, pentanediol, hexanediol, 1,4-cyclohexanedimethanol, diethylene glycol, other polyethylene glycols and mixtures thereof. Substrate 30 typically has low in-plane retardation, preferably less than 10 nm, and more preferably less than 5 nm. In some other cases, the substrate 30 may have larger in-plane retardation between 15 to 150 nm. Typically, when the substrate 30 is made of triacetyl cellulose, it has out-of-plane retardation around −40 nm to −120 nm. This is a desired property when the compensator is designed to compensate a liquid crystal state with an ON voltage applied. The in-plane retardation discussed above is defined as the absolute value of (nx−ny)d and the out-of-plane retardation discussed above is defined as [(nx+ny)/2−nz]d, respectively. The refractive indices nx and ny are along the slow and fast axes in plane of the substrate, respectively, nz is the refractive index along the substrate thickness direction (Z-axis), and d is the substrate thickness. The substrate is preferably in the form of a continuous (rolled) film or web.

On the transparent substrate 30, a series of parallel nanogrooves in the surface, these nanogrooves typically have a width of 1 to 500 nanometers, more preferably 5 to 100 nanometers. The nanogrooves also typically have a width of 1 to 500 nanometers, more preferably 5 to 100 nanometers. Below 1 nanometer width and depths are very difficult to produce and above 500 nanometers, the film starts to interfere with the wavelength of light and starts to create scattering and lost efficiency for a liquid crystal display. Typically, 5 to 100 nanometers in depth and height will create structures that will align the liquid crystal and minimize the light shaping tendencies of the structures. Preferably, the nanogrooves are at least 100 times in length what they are in width. Typically the nanogrooves are 100 micrometers to 5 centimeters in length for ease of manufactuability. Conveniently, the nanogrooves cover between 70 and 98% of the surface area so that most light passing through the film will pass through areas of aligned liquid crystals.

The plurality of nanogrooves are integral to the polymer sheet meaning that the film tends to have the same materials composition as the sheet and there is no well defined boundary as one would expect when examining a coated structure. Integral nanogrooves are advantaged over ultra violet coated and cured channels in that the conduits are integral, that is part of the polymer sheet rather than being applied to a polymer sheet, which creates unwanted interface issues such as delamination and cracking due to coefficient of thermal expansion differences between the channel materials and the sheet materials. Integral nanogrooves have the same thermal expansion coefficients and thus do not suffer from prior art interface issues, do not suffer from multiple optical surfaces which create unwanted Fresnel reflections, and can be produced with high levels of precision.

A method of fabricating the nanogrooves was developed. The preferred approach comprises the steps of providing a positive master extrusion roll having a plurality of inverse nanogrooves, meaning that there are pluralities of elongated nano-protrusions. The sheet is replicated from the master extrusion roller by casting the desired molten polymeric material to the face of the extrusion roll, cooling the desired polymer below the Tg of the polymer and then striping the polymer sheet containing the nanogrooves from the extrusion roll. The patterned roll can be created in many ways, such as photolithography, ion beam milling, and nanoscribing. The negative of the desired nanogroove pattern may also be machined into a thin metallic sheet and then wrapped around a roller. The nanogrooves of the invention may also be created by hot embossing, UV cure polymers, vacuum forming or injection molding.

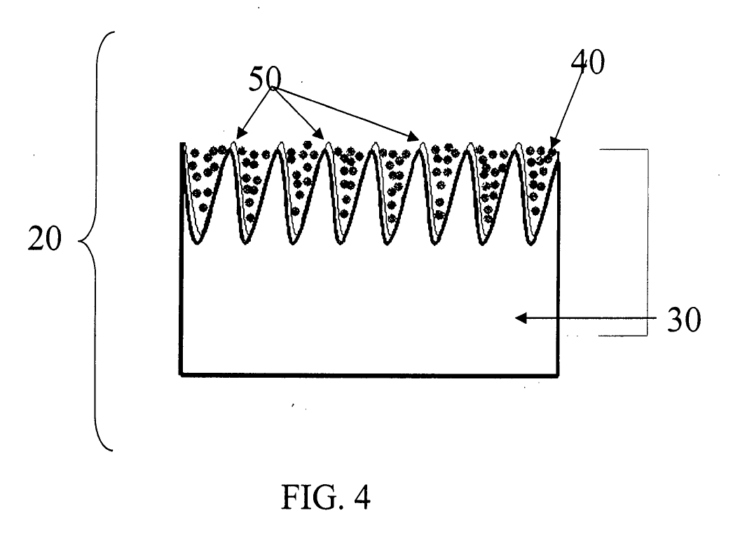

FIG. 3 shows a cross-sectional schematic view of an optical compensator 10 according to the present invention. The liquid crystal layer 40 is typically a liquid crystalline monomer when it is first disposed on the transparent substrate 30, and is crosslinked by a UV irradiation, or polymerized by other means such as heat. In a preferred embodiment, the liquid crystal polymers layer 40 contains a material such as a diacrylate or diepoxide with positive birefringence. The liquid crystal polymers layer 40 may also contain addenda such as surfactants, light stabilizers and UV initiators. UV initiators include materials such as benzophenone and acetophenone and their derivatives; benzoin, benzoin ethers, benzil, benzil ketals, fluorenone, xanthanone, alpha and beta naphthyl carbonyl compounds and ketones. Preferred initiators are alpha-hydroxyketones.

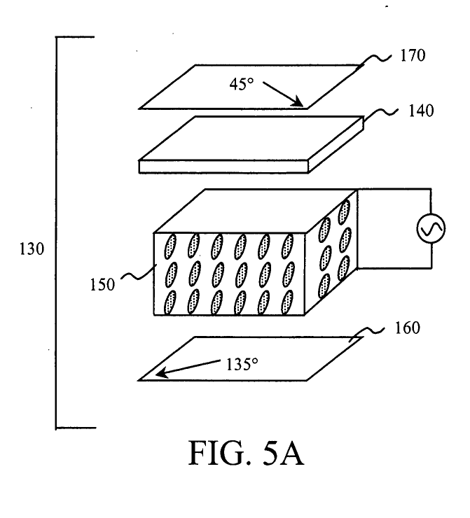

FIG. 4 shows a cross-sectional schematic view of a compensator 20 according to the present invention. On the substrate 30, a barrier layer 50 is applied for limiting the diffusion of processing chemical during manufacture and a liquid crystal layer 40 is disposed on top of barrier layer 50. The barrier layer 50 comprises a crosslinked polymer derived from one or more of the following waterborne or organic soluble resins, containing functional groups such as carboxylic, hydroxyl, amino or epoxy groups, such as melamine resins, guanamine resins, epoxy resins, diallyl phthalate resins, phenoxy and phenolic resins, alkyd and unsaturated polyester resins, polyurethane resins, polyolefin resins, aminoalkyd resins, melamine-urea copolycondensed resins, silicone and polysiloxane resins, certain types of acrylic and vinyl polymers, hydrogels such as polyvinyl alcohol and gelatin, and cellulosics such as nitrocellulose, ethyl cellulose, hydroxyethyl cellulose and carboxylated cellulose derivatives. Crosslinked polymers useful for the preparation of barrier layers of this invention are derived from reactions of the above defined crosslinkable functional groups with polyfunctional compounds containing groups such as isocyanate groups, epoxy groups, aziridene groups, oxazoline groups, aldehyde groups, carbonyl groups, hydrazine groups, methanol groups and active methylene groups. Also, a vinylsulfonic acid, an acid anhydride, a cyanoacrylate derivative, an etherified methylol, an ester or a metal alkoxide such as urethane and tetramethoxysilane can be used to introduce the crosslinked structure. A functional group which exhibits the crosslinking property as a result of the decomposition reaction such as blocked isocyanate may also be used. The crosslinkable group for use in the present invention is not limited to these compounds but may be a group which exhibits reactivity after the decomposition of the above described functional groups.

Crosslinked polymers are also called network polymers or thermosets. Suitable barrier layers are those that are impermeable or substantially impedes the passage of components in the support layer from passing into the liquid crystal layer and do not by themselves poison the liquid crystal layer as a results of their components. Suitable examples of crosslinked barrier layer polymers, useful in the practice of this invention are those derived from, melamine resins, acrylic resins, urethane resins, vinyl-urethane hybrid resins, vinyl resins, vinyl-acrylic resins, polyethylene resins, phenol formaldehyde resins, epoxy resins, amino resins, urea resins, and unsaturated polyester resins. Conveniently used examples are melamine resins, acrylic resins, urethane resins and polyethylene resins. More conveniently used examples are those derived from melamine resins.

An example of a crosslinkable resin that is commercially available is Cymel 300, a hexamethoxymelamine from Cytec Industries Inc. An example of a polyfunctional crosslinker useful in this invention is CX100, a trifunctional crosslinker, from NeoResins (a division of Avecia). An example of an acrylic resin useful in this invention is NeoCryl A633, from NeoResins (a division of Avecia). An example of a urethane resin useful in this invention is NeoRez R600, from NeoResins (a division of Avecia). An example of a vinyl-acrylic resin useful in this invention is Haloflex HA-202S, a vinyl-acrylic terpolymer from NeoResins (a division of Avecia).

In addition the barrier layer of this invention may also optionally comprise diluent polymers or resins such as polymethyl(meth)acrylates and other acrylic polymers, styrenic and other vinyl polymers, polyesters, polyurethanes, nitrile resins and the like.

Examples of solvents employable for coating the barrier layer into the polar solvents such as water, methanol, ethanol, n-propanol, isopropanol, and n-butanol, non polar solvents such as cyclohexane, heptane, toluene and xylene, alkyl halides such as dichloromethane and dichloropropane, esters such as methyl acetate, ethyl acetate, propyl acetate and butyl acetate, ketones such as acetone, methyl isobutyl ketone, methyl ethyl ketone, γ-butyrolactone and cyclopentanone, cyclohexanone, ethers such as tetrahydrofuran and 1,2 dimethoxyethane, or mixtures thereof. With the proper choice of solvent, adhesion between the transparent substrate film and the coating resin can be improved while the surface of the transparent plastic substrate film is not whitened, enabling the transparency to be maintained. Suitable solvents are methanol, mixtures of water and methanol, and propyl acetate.

After coating, the resin or the material having the crosslinkable groups must be crosslinked by heat or the like. For resins such as melamine resins an acid catalyst such as p-toluene sulfonic acid (PTSA) is used as a catalyst to accelerate the crosslinking reaction.

Resins useful as barrier layers of this invention may also be crosslinked using radiation curing such as ultraviolet or electron beam irradiation, and is preferably one having an acrylate functional group, and examples thereof include relatively low-molecular weight polyester resin, polyether resin, acrylic resin, epoxy resin, urethane resin, urethane-acrylic resins, alkyd resin, spiroacetal resin, polybutadiene resin, and polythiol-polyene resin, oligomers or prepolymers of (meth)acrylate (the term “(meth)acrylate” used herein referring to acrylate and methacrylate) or the like of polyfunctional compounds, such as polyhydric alcohols, and ionizing radiation-curable resins containing a relatively large amount of a reactive diluent. Reactive diluents usable herein include monofunctional monomers, such as ethyl (meth)acrylate, ethylhexyl (meth)acrylate, styrene, vinyltoluene, and N-vinylpyrrolidone, and polyfunctional monomers, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate. When the ionizing radiation-curable resin is used as an ultraviolet-curable resin, a photo polymerization initiator is incorporated into the ionizing radiation curable resin composition. Preferred radiation curable resins include acrylic, urethane, urethane-acrylic and epoxy resins. Additionally an auxiliary layer on top of or below the crosslinkable polymer layer may be applied to improve adhesion.

The crosslinkable polymer layer is suitably applied at dry coverages between 0.10 to 10 g/m², preferably between 0.55 and 5 g/m². The crosslinkable polymer is applied to the transparent support by known coating techniques. It may be dried using conventional techniques. The crosslinkable polymer as described above may be applied to one or both sides of the transparent substrate.

A process for forming an optical compensator includes the following steps of:
a) patterning the nanogrooves onto the transparent substrate;
b) coating a crosslinkable barrier layer on top of the transparent substrate;
c) drying and crosslinking the crosslinkable barrier layer;
d) coating a liquid crystal layer in organic solvents over the barrier layer;
e) drying the liquid crystal layer; and
f) crosslinking the liquid crystal layer.

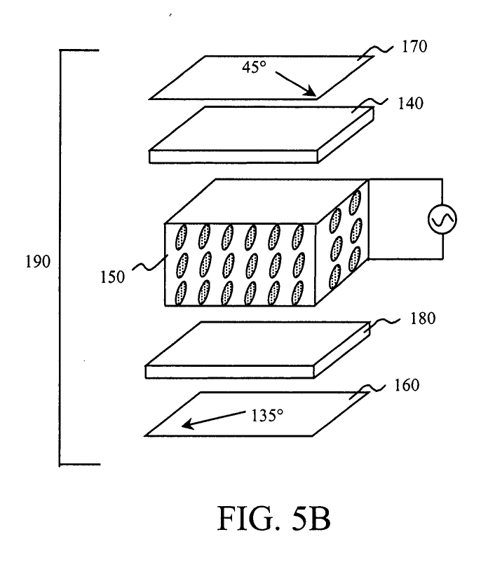

FIG. 5A shows a schematic liquid crystal display 130 where 140 is a single compensating film that is placed on one side of the liquid crystal cell 150. 160 is a polarizer, and 170 is a second polarizer. The transmission axes for the polarizers 160 and 170 form 90°±10° angle relative to each other. The angles of their transmission axes are denoted as 45° and 135° relative to the liquid crystal cell 150. However, other angles are possible depending on the kind of liquid crystal display 130 and this is obvious to those who skilled in the art. Note that liquid crystal cell 150 is an electrically switchable liquid crystal cell with the liquid crystals confined between two glass plates.

FIG. 5B shows another schematic liquid crystal display 190 where there are two compensating films 140, 180 placed on both sides of the liquid crystal cell 150. 160 is a first polarizer and 170 is a second polarizer. The transmission axes for the polarizers 160 and 170 form a 90°±10° angle relative to each other. The angles of their transmission axes are denoted as 45° and 135° relative to the liquid crystal cell 150. However, other angles are possible depending on the kind of liquid crystal display 130 and this is obvious to those who skilled in the art. Note that 150 is the electrically switchable liquid crystal cell with the liquid crystals confined between two glass plates.

The liquid crystal cell 150 is preferred to be operated in a Multi-domain Vertically Aligned (MVA), a Twisted Nematic (TN), a Super Twisted Nematic (STN), Optically Compensated Blend (OCP), or In-Plane-Switching (IPS) mode.

The entire contents of the patents and other publications referred to in this specification are incorporated herein by reference.

### PARTS LIST

10 Compensator according to the present invention
20 Compensator according to the present invention
30 Transparent substrate according to the present invention
40 Oriented liquid crystal material
50 Barrier layer
60 Plane of oriented liquid crystal layer
78 Plane of substrate (or XY plane)
80 XYZ coordinate system
86 Optical axis in the liquid crystal layer
130 Liquid crystal display
140 Compensator
150 Liquid crystal cell
160 Polarizer
170 Polarizer
180 Compensator
190 Liquid crystal display
φ Azimuthal angle

1. A liquid crystal alignment layer comprising a transparent substrate bearing a series of parallel nanogrooves in the surface thereof and containing in the nanogrooves an oriented liquid crystal material.

2. The layer of claim 1 wherein the transparent substrate comprises a polymer.

3. The layer of claim 1 wherein the transparent substrate comprises a thermoplastic polymer.

4. The layer of claim 1 wherein the transparent substrate comprises a thermoset polymer.

5. The layer of claim 1 wherein the transparent substrate comprises a triacetylcellulose (TAC), polycarbonate, cyclic polyolefin or polyarylate.

6. The layer of claim 1 wherein the transparent substrate comprises a polymer having a negative birefringence.

7. The layer of claim 1 wherein the transparent substrate comprises a polymer having a positive birefringence.

8. The layer of claim 1 wherein the nanogrooves have a depth of 1 to 500 nanometers.

9. The layer of claim 1 wherein the nanogrooves have a depth of 5 to 100 nanometers.

10. The layer of claim 1 wherein the nanogrooves have a width of 1 to 500 nanometers.

11. The layer of claim 1 wherein the nanogrooves have a width of 5 to 100 nanometers.

12. The layer of claim 1 wherein the nanogrooves have a length at least 100 times the width of the nanogrooves.

13. The layer of claim 1 wherein the nanogrooves cover between 70 and 98% of the surface area of the layer.

14. The layer of claim 1 wherein the oriented liquid crystal material is positively birefringent.

15. The layer of claim 1 wherein the oriented liquid crystal material is negatively birefringent.

16. The layer of claim 1 wherein the liquid crystal material comprises a UV crosslinked material.

17. The layer of claim 1 wherein the optic axis of the liquid crystal has a fixed azimuthal angle.

18. The layer of claim 1 wherein the optic axis of the liquid crystal has a variable azimuthal angle.

19. A liquid crystal cell comprising alignment layers for the upper and lower inside faces of the liquid crystal display cell comprising a transparent substrate bearing a series of parallel nanogrooves in the surface with an oriented liquid crystal material in the nanogrooves.

20. A liquid crystal display comprising the cell of claim 19.

21. A compensator for a liquid crystal display containing an alignment layer comprising a transparent substrate bearing a series of parallel nanogrooves in the surface with an oriented liquid crystal material in the nanogrooves.

22. A liquid crystal display comprising the compensator of claim 21.

23. The display of claim 22 including a vertically aligned (VA) LC cell, a Multi-domain Vertically Aligned (MVA) cell, a Twisted Nematic (TN) cell, a Super Twisted Nematic (STN) cell, Optically Compensated Blend (OCP) cell, or an In-Plane-Switching (IPS) cell.

24. The display of claim 23 comprising a VA cell.

25. The display of claim 23 comprising an IPS cell.

26. The display of claim 22 additionally comprising a barrier layer for limiting the diffusion of processing chemicals during manufacture.

27. The display of claim 26 wherein the barrier layer comprises a crosslinked melamine, epoxy, phenoxy, alkyd, polyester, acrylic, vinyl or cellulosic resin.

28. The display of claim 26 wherein the barrier layer comprises a crosslinked polymer derived from a resin containing carboxylic, hydroxyl, amino or epoxy groups.

29. A process for making the layer of claim 1 comprising extruding molten polymeric material onto a patterned roll to form the nanogrooves upon cooling and thereafter introducing a liquid crystal material into the grooves whereby an oriented liquid material is formed.

30. The process of claim 29 including the subsequent step of crosslinking the liquid material to fix its orientation.

31. A process for forming an optical compensator of claim 21 comprising the steps of:
a) patterning the nanogrooves onto the transparent substrate;
b) coating a crosslinkable barrier layer on top of the transparent substrate;
c) drying and crosslinking the crosslinkable barrier layer;
d) coating a liquid crystal layer in organic solvents over the barrier layer;
e) drying the liquid crystal layer; and
f) crosslinking the liquid crystal layer.
